(19) United States
(12) Patent Application Publication
(10) Pub. No.: US 2006/0229406 A1
(43) Pub. Date: Oct. 12, 2006

(54) Process for uniformly dispersing particles in a polymer

(76) Inventors: Lee A. Silverman, Newark, DE (US); Jose Manuel Rodriguez-Parada, Hockessin, DE (US); Maria Petrucci-Samija, Wilmington, DE (US); John A. Fox, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/387,410

(22) Filed: Mar. 23, 2006

Related U.S. Application Data
(60) Provisional application No. 60/664,869, filed on Mar. 24, 2005.

(51) Int. Cl. C09D 5/02

(52) U.S. Cl. 524/501

(57) ABSTRACT

This invention relates to a process to disperse fine particles in a polymer solution or matrix, and to the composition prepared by such process.

This application claims the benefit of U.S. Provisional Application No. 60/664,869, filed 24 Mar. 2005, which is incorporated in its entirety as a part hereof for all purposes.

### TECHNICAL FIELD

The present invention relates to a process to disperse fine particles in a polymer solution or matrix, and the composition obtained thereby. The composition containing such dispersion can in turn be used to make coatings, films, sheets and molded objects with modified properties such as optical-properties. These films can be adhered to substrates or laminated between layers of glass to create glazing that has an infrared cutoff or other function.

### BACKGROUND

Mahler (U.S. Pat. No. 4,738,798) provides a method to make ultrafine inorganic particles in an ionomer layer. Materials were formed in this process via an in-situ precipitation of inorganic particles by the reaction of metal ions dissolved within an ionomer layer with a gaseous reactant that is diffused into the ionomer. Examples of many particle chemistries were made with particle sizes between 2 and 20 nm, and more typically less than 10 nm. Optical filters were created that generally absorbed light at visible wavelengths while they were transparent in the near infrared region.

Lane (U.S. Pat. No. 4,478,812) provides a method for precipitating a powder in the presence of a polymer, and subsequently removing the polymer phase during calcination at elevated temperatures to produce powders with high surface areas.

Sato et al (U.S. Pat. No. 4,937,148) provide a method for precipitating antimony-doped tin oxide (ATO) and tin-doped indium oxide (ITO) in an aqueous environment, subsequently drying and calcining this material to obtain fine particles. The dry powder was subsequently combined with polymer resins to form particle filled polymer materials. Similar methods are disclosed in Hirai et al. (U.S. Pat. No. 5,376,308), Hayashi and Yoshimaru (U.S. Pat. No. 5,772,924), and Kunimatsu and Yamazaki (U.S. Pat. No. 5,807,511).

Nishihara, Hayashi and Sehiguchi (U.S. Pat. No. 5,518,810) provide a method for making an infrared cutoff material by dispersing indium tin oxide (ITO) in a matrix. Antimony-doped tin oxide (ATO) is used in comparative examples. The powders were formed by calcining hydrous precipitates under various conditions to create ITO powders that absorb wavelengths closer to the visible range than the comparative ATO examples.

Kondo (U.S. Pat. No. 5,830,568, U.S. Pat. No. 6,315,848 and U.S. Pat. No. 6,329,061) provides a method for functionalizing a laminated glass structure by dispersing a single kind of ultrafine particles in the interlayer. Dried and calcined ATO and ITO, as well as cobalt aluminate, and other complex mixtures of oxides, were generally mixed into plasticizers, and the suspensions were subsequently kneaded with the interlayer resin. The resulting material was extruded to form an interlayer and finally laminated between layers of glass. In one example, the dry powder was mixed into the fully plasticized polymer. Preferred ranges for particle sizes are 1 to 200 nm, more preferably 1 to 150 nm or 2 to 150 nm, and still more preferably from 1 to 100 nm or 2 to 100 nm. Particle concentrations are preferable up to 10% of the weight of the interlayer film.

Kase and Akayama (U.S. Pat. No. 5,925,453) provide a method for producing and adhering a solar control film to the surface of a layer of glass. In this reference, the solar control film is comprised of reflecting and absorbing layers.

Adachi, Takeda and Kuno (U.S. Pat. No. 6,060,154) provide a method to make solar control films by depositing small particles of inorganic materials from solution. Dried fine powders were milled into solvents using zirconia balls, mixed with ethyl silicate solutions, cast onto substrates and finally calcined to form the finished film.

Nutz and Haase [J. Phys. Chem. B 104 (2000) pages 8430-8437] modify aqueous dispersions of ATO nanoparticles using a hydrothermal route under reducing conditions. This process is used to convert the ATO to a state that absorbs strongly in the near infrared range. Autoclave temperatures must be above 250° C.

Precipitation of inorganic particles can, in general, be conducted either in organic or aqueous environments. Of these two methods, industrial production levels are easier to achieve with aqueous precipitation because the raw materials, including water, are inexpensive relative to solvents and hydrophobic metal salts. In addition, the solubility of hydrophilic metal salts in water is usually much higher than the solubility of hydrophobic metal salts in an organic solvent. In addition, once the particles have formed, it is easier to stabilize them in water because the polar nature of water supports strong electrical double layers around the particles. These double layers prevent the particles from coming into contact with each other and thereby becoming agglomerated. It is thus not only economically more favorable to precipitate particles in water-based systems, but the final suspensions are easier to stabilize.

For example, in order to function as a solar control device without dramatically reducing the amount of visible light that is transmitted, a composition should contain ultrafine particles that preferentially absorb wavelengths in the near infrared portion of the solar spectrum. ATO, like most transparent conductive oxides, must have a specific oxidation state in order to have the appropriate spectral properties.

In order to achieve the desired oxidation state, most processes to produce infrared-absorbing ATO involve the precipitation of a powder, and subsequently heating the powder to an elevated temperature where crystallization is enhanced. In this process, dopant ions are substituted on lattice sites, and proper oxidation states of the ions are set. Unfortunately, there are usually disadvantages that accompany a dry powder calcination process such as particle growth, particle faceting and agglomeration. Agglomeration is a very serious issue because the particles are usually contacting one another during a calcination process, and at elevated temperatures, where ions are mobile, interparticle necking and sintering occurs. This is especially problematic in the case of small particles, where the driving force for interparticle neck formation is high due to the very high surface area to volume ratio. This process is enhanced even further in the case of nanosized particles.

In contrast to a calcination process, hydrothermal processes have been shown to produce materials with similar optical properties to those that have been calcined. In the Nutz and Haase reference cited above, a procedure is disclosed for producing a blue ATO suspension with average particle sizes between 4 and 9 nm. In order to practice this technology, powders produced via aqueous precipitation must be hydrothermally treated at temperatures in excess of 250° C. in glass or glass-lined autoclaves. Glass must be used in this process because the temperatures involved exceed the maximum working temperature of most polymers, and fluoropolymers in particular. The necessary use of glass is not optimal as a large external pressure must be applied to prevent water evaporation. In addition, because many suspensions are produced under alkaline conditions, the base-contained within the suspension may tend to slowly corrode the glass vessel, leading to unsafe operating conditions and unsatisfactory impurity levels in the suspension. Also, in this process, the suspension is dried by rotary evaporation. Evaporation of a solvent from a suspension of particles leads to very tightly agglomerated materials due to the capillary action of the solvent at the point where the meniscus of the liquid penetrates the surface of the agglomerate. This force compacts the particles strongly and makes them difficult to redisperse in liquids. In many cases where optical transmission is important, agglomerates are detrimental because even though they are capable of scattering light with less efficiency than single particles of the same dimension, they still scatter light at considerable levels. For this reason and others, agglomerated particles should be avoided.

Dispersions of particles in water are difficult to transfer to organic polymers as very few organic polymers are soluble in water. As a result, most powders that are precipitated in water are dried and subsequently put into an organic solvent or plasticizer, which is then blended with the polymer, or the dried powder is compounded directly into the polymer matrix. As drying results in agglomeration for the reasons previously noted, suspensions of previously dried powders in solvents and plasticizers usually must be milled using media mills. These mills add impurities to the suspension in the form of ionic species and milling debris. In the case of milling ultrafine particles, the amount of debris can be considerable, and the size of the debris is usually much larger than the original particles that are being deagglomerated. Large particles of milling media, usually alumina or zirconia, lead to large amounts of scattering due to the large refractive index contrast between the polymer matrix and the milling debris. Removal of milling debris is usually done by filtration or sedimentation, which adds expense to the production process.

For these reasons, Applicant has found it beneficial to design a process that begins with an aqueous dispersion of particles and in which the particles are kept dispersed in a single-phase liquid medium. Solvent may eventually be extracted in connection with fabrication or to prepare a dried composition as the final product.

### SUMMARY

One embodiment of this invention is a process for dispersing particles in a polymer by

(a) providing an aqueous dispersion of particles,

(b) admixing with the aqueous dispersion of particles at least one solvent that is miscible with water and does not undergo liquid-liquid phase separation as water is removed from the dispersion,

(c) removing water from the dispersion, and

(d) adding to the dispersion at least one polymer that is soluble in the solvent.

Another embodiment of this invention is a process for dispersing particles in a polymer by

(a) providing an aqueous dispersion of particles,

(b) admixing with the aqueous dispersion of particles at least one solvent that is miscible with water and does not undergo liquid-liquid phase separation as water is removed from the dispersion,

(c) adding to the dispersion at least one polymer that is soluble in the solvent, and

(d) removing water from the dispersion.

A further embodiment of this invention is a process for dispersing particles in a polymer by

(a) providing an aqueous dispersion of particles,

(b) admixing with the aqueous dispersion of particles at least one solvent that is miscible with water and does not undergo liquid-liquid phase separation as water is removed from the dispersion,

(c) removing water from the dispersion,

(d) adding to the dispersion at least one polymer precursor that is soluble in the solvent, and

(e) polymerizing the precursor to form within the dispersion at least one polymer.

Yet another embodiment of this invention is a process for dispersing particles in a polymer by

(a) providing an aqueous dispersion of particles,

(b) admixing with the aqueous dispersion of particles at least one solvent that is miscible with water and does not undergo liquid-liquid phase separation as water is removed from the dispersion,

(c) adding to the dispersion at least one polymer precursor that is soluble in the solvent,

(d) polymerizing the precursor to form within the dispersion at least one polymer, and

(e) removing water from the dispersion.

Yet another embodiment of this invention is a composition of matter that includes particles and at least one polymer,

wherein the particles have an average diameter of less than 200 nm, are dispersed in the polymer(s) and are present in the composition in an amount of at least about 1% based on the combined weight of the particles and the polymer(s), and

wherein the composition has a haze not exceeding 5% as determined according to ASTM D-1003-61.

### BRIEF DESCRIPTION OF THE DRAWINGS

FIG. 1 shows a transmission spectrum of hydrothermally treated ATO in water in a cell with a 100 micrometer path length, as compared to an air reference.

FIG. 2 shows a transmission spectrum of a 35 micrometer-thick coating of ATO-functionalized PVB on glass.

FIG. 3 shows a transmission spectrum of a 25 micrometer-thick coating of ATO-functionalized PVB on glass.

FIG. 4 shows a cross-section of a three layer structure on silicon, the middle layer being erbium and ytterbium-doped calcium fluoride-filled partially fluorinated acrylic polymer.

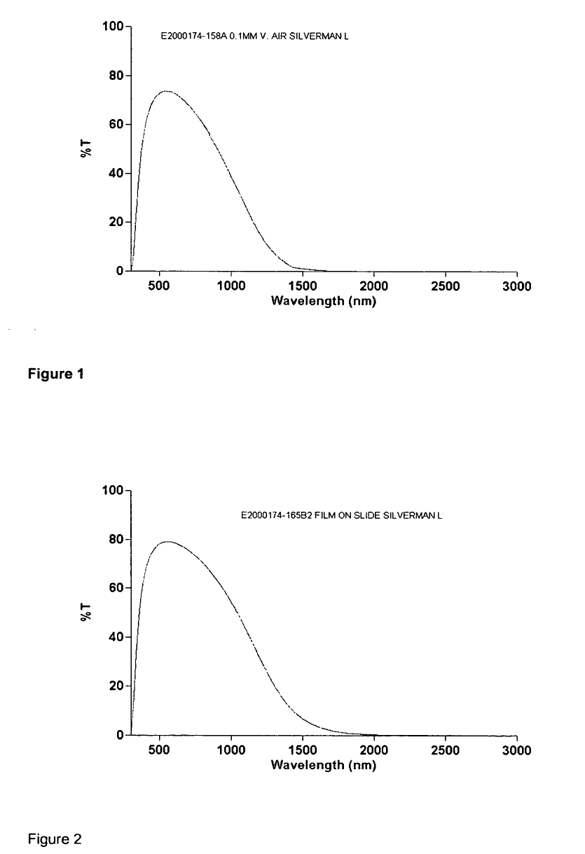

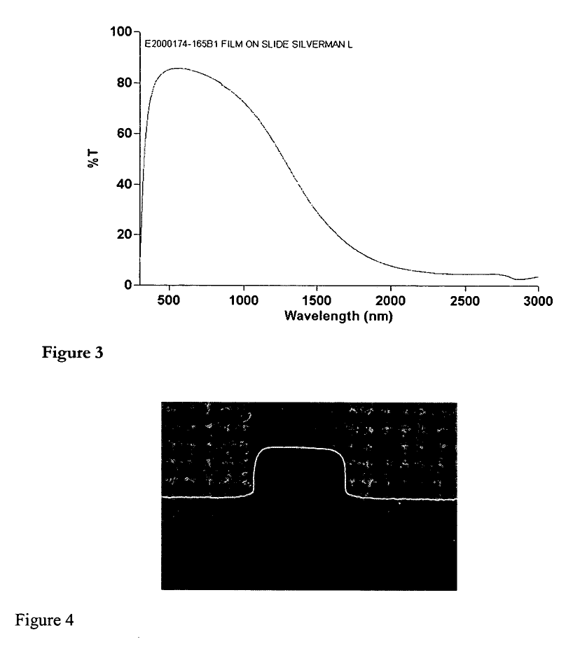

### DETAILED DESCRIPTION

In one embodiment, this invention provides a process for the preparation of a composition of matter in which particles are dispersed in a solution of a polymer or in a polymer matrix. These compositions, and coatings, films, sheets and articles fabricated therefrom, have dispersed therein ultrafine particles that have an average particle diameter of up to about 200 nm.

In the preparation of a composition as described herein, particles are initially provided or formed in an aqueous phase, and are then stabilized in a solution of a polymer, preferably a hydrophobic polymer. Upon fabrication or drying, a matrix of the polymer with the particles dispersed therein is formed. The process begins with the preparation of an aqueous dispersion of particles, and the particles are thereafter kept dispersed in a single-phase liquid medium. Solvent may eventually be extracted in connection with fabrication or to prepare a dried composition as the final product.

This process produces compositions in which particles are very small and well dispersed throughout a polymer, resulting in compositions with desirable optical properties, such as very low levels of haze, even though the total loading of particles may be quite high. The process may further involve creating a master batch that has a high concentration of particles dispersed in a small amount of the polymer wherein the master batch is subsequently diluted with additional polymer prior to further use. For example, stable suspensions of particles such as ATO, after optimization of the infrared cutoff wavelength, can be combined with ionomer resins to create infrared-blocking ionomer compositions. All of the compositions disclosed herein are useful for fabrication as coatings, cast films, interlayers in glass laminates and shaped objects.

In one embodiment, ultrafine particles may be obtained from materials such as ATO, rare earth doped-calcium fluoride, or other particles that may or may not be functionalized. These particles may be used to absorb near-infrared radiation, thereby reducing the heating of an automobile or building due to sunlight, while at the same time scattering only small amounts of visible light so that coatings, films and interlayers formed from these compositions have very low amounts of haze. As such, these compositions are useful in coatings, films, sheets and articles that satisfy all requirements for architectural and automotive glazing applications, and these compositions provide the additional function of preferentially reducing the transmission of near infrared radiation to the interior of a building or car among other properties. Optionally, ultrafine particles may have other functions. They may, for example, be magnetic, electrochromic, photochromic, thermochromic, phosphorescent, electroluminescent or fluorescent where desirable.

In other embodiments of the composition of this invention, the particles, or the components thereof, may be selected from the group consisting of metals, compounds containing the metals, and composites containing the metals. These metals may include Sn, Ti, Si, Zn, Zr, Fe, Al, Ca, Cr, Co, Ce, In, Ni, Ag, Cu, Pt, Mn, Ta, W, V, Mo and mixtures of two or more thereof. Compounds containing the metals may include oxides, nitrides, phosphates, oxynitrides, fluorides and/or sulfides of the metals. Composites containing the metals may include one or more metals doped with at least one substance, and/or one or more metal compounds doped with at least one substance. Dopants may be selected from the group of materials consisting of antimony, antimony compounds, fluorine, fluorine compounds, stannous compounds, and aluminum compounds. In a preferred embodiment, clay particles, such as smectic clay particles, are excluded from the particles that are contained in the compositions of this invention

Oxides of metals suitable for use herein as particles may include SnO₂, TiO₂, SiO₂, ZrO₂, ZnO, Fe₂O₃, Al₂O₃, FeO, Cr₂O₃, CO₂O₃, CeO₂, In₂O₃, NiO, MnO and CuO. Exemplary commercial products of such oxides include particles made of TiO₂ under the trade name IT-S-UD from Idemitsu Petrochemical Co., Ltd. These particles have an average particle diameter of about 0.02 μm. Particles made under the trade name UFO1 by Tai Oxide Chemicals Co., which have an average particle diameter of about 0.018 μm, are also suitable for use herein. An exemplary commercial product of particles made of Fe₂O₃ is made by Showa Denko K.K. under the trade name Nanotite. These particles are in the form of spherical ultra-fine hematite particles, and have an average particle diameter of about 0.06 μm. Other particles suitable for use herein may include nitrides of metals such as TiN and AIN, sulfides of metals such as ZnS, and fluorides of metals such as CaF₂.

Doped metals suitable for use herein may include SnO₂ doped with about 9 wt % Sb₂O₃ (ATO made by Sumitomo Osaka Cement Co.), SnO₂ doped with fluorine, and SnO₂ doped with about 10 wt % Sb₂O₃. Composites that contain at least two of the above-mentioned metals and are suitable for use herein may include In₂O₃/5 wt % SnO₂ (ITO made by Mitsubishi Material Co.); and inorganic pigment ultra-fine particles such as CO₂O₃/Al₂O₃ (e.g. TM3410, having an average particle diameter of from about 0.01 to about 0.02 μm), TiO₂/NiO/CO₂O₃/ZnO (e.g. TM3320, having an average particle diameter of from about 0.01 to about 0.02 μm), and Fe₂O₃/ZnO/Cr₂O₃ (e.g. TM3210, having an average particle diameter of from about 0.01 to about 0.02 μm). TM3410, TM3320 and TM3210 are product designations of particles made by Dai Nichi Seika. Kogyo Co.

The average diameter of a primary particle in a dispersion of this invention may vary, but is less than about 200 nm, preferably less than about 100 nm, more preferably less than about 50 nm, and most preferably less than about 20 nm. The diameter of a particle is the length of the largest dimension of the cross section of the particle that has the greatest area, whether the cross section is actually circular or not. Particles of a material may exist in various sizes, and a particle of a material that has reached the smallest possible size, i.e. a particle that may not be further reduced in size and remain a particle is a primary particle. Particles of a material that are larger than a primary particle are thus agglomerates or flocculates of a group of primary particles.

An aqueous dispersion of particles, such as ATO particles, can be prepared by a variety of methods. In the case of ATO, for example, a suitable method of preparation involves the neutralization of a solution of antimony and tin chlorides at low pH with ammonium hydroxide, followed by washing and peptizing under alkaline conditions. ATO particles suitable for use herein may be also be purchased from vendors such as Nyacol Nano Technologies, Inc., for example under product designation DP5730A.

While it is preferable in an aqueous dispersion as used herein to maintain a high particle concentration in order to minimize the amount of water removed in later processing steps, water may optionally be added to a dispersion where it is desired to increase the separation between particles in the dispersed state. The added water may, for example, contain acids or bases to enhance the stability of the dispersion prior to further processing. Another optional step may be a hydrothermal step where the particles are heated in water. The temperature of the water used in a hydrothermal step may exceed 100° C. if the apparatus is capable of containing the pressure exerted by the water vapor at elevated temperatures. A hydrothermal step may, for example, improve the crystallinity of the particles.

A solvent is then added to the aqueous dispersion of particles wherein the particles are soluble in the solvent, and the solvent is completely miscible with water and is used to extract the water. A non-aqueous solvent such as an organic solvent is typically suitable for use for this purpose. Preferred are those solvents that boil at a temperature greater than 100° C., although solvents that form azeotropes with water such that water can be removed during distillation may be usefully employed as well. Examples of useful solvents include methanol, ethanol, N,N-dimethylformamide, N-methyl-2-pyrrolidinone and N,N-dimethylacetamide, with N,N-dimethylformamide and N,N-dimethylacetamide being preferred. In addition to single solvents, mixtures of solvents that meet these conditions may also be usefully employed.

Water is then removed from the dispersion. While distillation, at either atmospheric, reduced or elevated pressure, is the preferred method for removing water, it is possible to remove water from the dispersion by other methods such as the use of molecular sieve dryers, and chemicals that react with water to form extractable materials. These materials preferably are subsequently removed from the composition during fabrication or drying, but this is not required. If water is to be removed by distillation, the resulting process mixture is brought to reflux, and water, or a water/solvent mixture, is distilled out, leaving the particles dispersed in the solvent.

The solvent used should not, with the removal of water as the process progresses, participate in the formation of more than one phase in the presence of water due to liquid-liquid phase separation. Phase separation may be detected visually, but, if droplets of one phase that have formed are too small to be reliably detected visually, their presence may be detected by determining whether there has been an increase in the haze of the process mixture during the progress of water removal. It is preferred that the haze of the mixture, as a result of the removal of water from the dispersion, be maintained at as low a level as possible, and, in order of increasing preference, the haze will desirably not exceed a value such as about 5.0%, about 3.0%, about 2.0%, about 1.0% or about 0.5%. Haze is determined as set forth below.

Substantially all, and preferably all, of the water is removed from the dispersion. Substantially all the water is removed when any water remaining in the dispersion is in an amount that is low enough that there is no phase separation of the remaining water and the solvent, and that all particles are dispersed in the solvent. Removal of water will form a process mixture that contains only primary particles or primary particles admixed with some reversibly-flocculated particles. Reversibly-flocculated particles are those particles that are separated during subsequent processing into primary particles, or are separated during subsequent processing into flocculates that are small enough such that the presence of any those small flocculates together with primary particles does not cause the dispersion to have a haze that exceeds a value, in order of increasing preference, such as about 5.0%, about 3.0%, about 2.0%, about 1.0% or about 0.5%.

A surfactant that is soluble in water, soluble in the solvent chosen, and soluble in the liquid solution formed between the chosen solvent and water may optionally be added to the process mixture before removal of the water. Examples of suitable surfactants include those such as alkyl phosphates, alkoxysilanes, chlorosilanes, and polymers or copolymers such as polyethylene oxides, polyvinyl alcohols and surface-active block copolymers. Preferred surfactants include a nonionic surfactant such as C₁₄H₂₂O(C₂H₄O)ₙ where n is 9 or 10 (sold as Triton X 100 octyl phenol ethoxylate); or 3(trimethoxy)propylmethacrylate, a reactive surfactant. A surfactant will bind to the surface of a particle and create a stearic impediment to the formation of flocculates by a group of such particles.

It may also be desirable to functionalize the surfaces of the particles at this point in the process. Functionalization of a particle is accomplished by bonding to the surface of the particle a group or moiety that enables the particle to interact chemically with a polymer in a different manner than the particle would be able to do if the group or moiety were not present, and the choice of functional group is thus made in terms of compatibility with the polymer(s) contained in the composition. Functionalization of particles may be accomplished by adding to the process mixture surfactants similar to those mentioned above.

Hygroscopic surface treatments may be used after removal of water from the system, however, as very little water, if any, remains in the system at that stage of the process. These treatments include, for example, the introduction of functional alkoxysilanes, chlorosilanes or other silanes that will react with the hydroxylated particle surfaces to form functional layers, or will engage in other reactions that are possible only when there is very little or no water present. Other materials that may be used in a hygroscopic surface treatment include aliphatic hydrocarbon chlorosilanes or alkoxysilanes, glycidoxy-functionalized chlorosilanes or alkoxysilanes, and acryloxy-functionalized chlorosilanes or alkoxysilanes.

At this stage, (i) a polymer, (ii) a solution of a polymer dissolved in a solvent that forms a complete solution with the solvent already present, and/or (iii) a precursor to polymer formation, such as a monomer and/or oligomer, or two or more of any of the foregoing, is added to the existing particle dispersion to form one embodiment of a composition of this invention. The polymer added to the dispersion, or the polymer formed from the precursors added to the dispersion, should have negligible solubility in water if any at all, yet must be soluble in the solvent that was added before water removal. Poly(vinylbutyral), for example, is not soluble in water but is soluble in solvents such as N,N-dimethylacetamide and N,N-dimethylformamide. Other polymers that are similarly useful in view of their solubility characteristics include ethylene-vinyl acetate copolymers, acrylic polymers and copolymers, methacrylic polymers and copolymers, styrenic polymers and copolymers, epoxy-containing polymers and copolymers, ionomers, and diblock copolymers in which one block has substantial compatibility with the particles in the dispersion and the other block has negligible compatibility therewith.

Where a polymer such as an acrylic polymer is polymerized from monomers in the process mixture, acrylic monomers that are soluble in a broad range of organic solvents but are negligibly soluble in water, such as methyl methacrylate, can be used for this purpose. Other similarly useful acrylic monomers include those sold by the Sartomer Company, Inc. (Exton, Pa., such as 2(2-ethoxyethoxy) ethyl acrylate, 2-phenoxyethyl acrylate, 2-phenoxyethyl methacrylate, acrylate ester, acrylic ester, alkoxylated lauryl acrylate, alkoxylated phenol acrylate, alkoxylated tetrahydrofurfuryl acrylate, alkyl methacrylate, caprolactone acrylate, cyclic trimethylolpropane formal acrylate, dicyclopentadienyl methacrylate, diethylene glycol methyl ether methacrylate, ethoxylated hydroxyethyl methacrylate, ethoxylated nonyl phenol acrylate, ethoxylated nonyl phenol methacrylate, isobornyl acrylate, isobornyl methacrylate, isodecyl acrylate, isodecyl methacrylate, isooctyl acrylate, lauryl acrylate, lauryl methacrylate, methoxy polyethylene glycol monoacrylate, methoxy polyethylene glycol monomethacrylate, octyldecyl acrylate, polyethylene glycol dimethacrylate, polypropylene glycol monomethacrylate, propoxylated allyl methacrylate, stearyl acrylate, stearyl methacrylate, tetrahydrofurfuryl acrylate, tetrahydrofurfuryl methacrylate, tridecyl acrylate, tridecyl methacrylate, and triethylene glycol ethyl ether methacrylate. Suitable reactive monomers that can be polymerized in the process mixture include styrenic monomers, and epoxy-containing monomers.

Stabilizers, antioxidants, plasticizers and other additive packages known to be useful during the processing and use of polymeric systems and articles may also be added to the process mixture. A stabilizer protects a polymer from degradation during processing and service life. Suitable stabilizers may include sterically hindered phenols, benzophenones, diphenyl acrylates, cinnamates, sterically hindered amines and the like. An antioxidant protects a polymer from oxidative degradation. Suitable antioxidants may include secondary aromatic amines and sterically hindered phenols. A plasticizer aids a polymer in retaining its ability to deform. Suitable plasticizers may include dibutyl and dioctyl esters, long chain hydrocarbons, tri(ethyleneglycol) bis(2-ethylhexanoate) and the like. Other suitable polymer additives, as discussed in Plastics Additive Handbook, Hans Zweifel, Editor, Hanser Gardner Publications (Munich and Cincinnati, 2001), may also be added at this stage of the process if desired.

If reactive groups, such as those present on monomers, are included in the formulation, initiators that are compatible with the polymerization energy of the monomer system, such as 2,2′-azobisisobutyronitrile or Irgacure 184 (Ciba Specialty Chemicals, Basel, Switzerland) may also be added at this stage to accelerate the reaction of those groups at some later time due to exposure to heat or ionizing radiation. Numerous photoinitiators, which act in the presence of ionizing radiation, are suitable for use for such purpose.

After (i) addition to the process mixture of one or more polymers and/or (ii) the polymerization in the process mixture of one or more polymer precursors, the process mixture is a dispersion of particles within the dissolved polymer(s), and forms one embodiment of a composition of this invention. The compatibility of the polymeric species with the surface of the particles provides a stearic impediment to the formation of large flocculates, and the particles are thus present in the dispersion substantially only, and preferably only, in the form of primary particles, or primary particles admixed with small flocculates. Small flocculates are those that, when present together with primary particles, are small enough such that the presence of any those small flocculates together with primary particles does not cause the dispersion to have a haze that exceeds a value, in order of increasing preference, such as about 5.0%, about 3.0%, about 2.0%, about 1.0% or about 0.5%. To maximize the extent of the dispersion of the particles within the dissolved polymer system, and to assist in the reduction of the size of any flocculated particles to a size giving the haze properties stated above, the dispersion may be mixed at high shear if desired.

It will be necessary to remove solvent from the process mixture to be able to use the composition contained in the dispersion as a dried product itself, or for the purpose of fabrication. If a dried product such as a powder is desired, conventional drying techniques may be employed such as oven baking. If it is desired to use the composition contained in the dispersion for fabrication, the amount of solvent removed will be determined by the viscosity desired in view of the type of fabrication steps to be performed. Coating, film forming and molding operations will require differing degrees of viscosity. Solvent removal does not cause particle flocculation or cause any existing flocculates to increase in size. Upon the removal of solvent to prepare a dried product or during fabrication, the particles remain dispersed in a matrix of the polymer(s).

In a composition of this invention as contained in the dispersion in solution, or as contained in the particle dispersion in the polymer matrix, particles may be present in an amount of at least about 1%, preferably at least about 5%, more preferably at least about 10%, and most preferably at least about 20% where the percentage is determined as the ratio of the weight of the particles to the weight of the polymer(s) present. A composition of this invention will have a haze that does not exceed a value, in order of increasing preference, such as about 5.0%, about 3.0%, about 2.0%, about 1.0% or about 0.5%.

In an alternative embodiment, (i) a polymer, (ii) a solution of a polymer dissolved in a solvent that forms a complete solution with the solvent added before water removal, and/or (iii) a precursor to polymer formation, such as a monomer and/or oligomer, or two or more of any of the foregoing, may be added to the particle dispersion before the removal of water. In this embodiment, after addition to the process mixture of one or more polymers and/or the polymerization in the process mixture of one or more polymer precursors, the process mixture is a dispersion of particles within the solution of the polymer(s) dissolved in the solvent. The compatibility of the polymeric species with the surface of the particles provides a stearic impediment to the formation of flocculates, and the process mixture will at this stage contain substantially only, and preferably only, primary particles, or primary particles admixed with some reversibly-flocculated particles. Reversibly-flocculated particles are those particles that are separated during subsequent processing into primary particles, or are separated during subsequent processing into small flocculates. Small flocculates are those that, when present together with primary particles, are small enough such that the presence of any those small flocculates together with primary particles does not cause the dispersion to have a haze that exceeds a value, in order of increasing preference, such as about 5.0%, about 3.0%, about 2.0%, about 1.0% or about 0.5%.

Substantially all, and preferably all, of the water is then removed from the dispersion. Substantially all the water is removed when any water remaining in the dispersion is in an amount that is small enough that there is no phase separation of the water and the solvent, and that all particles are dispersed in the dissolved polymer(s). Removal of water will form a process mixture, and thus also another embodiment of a composition of this invention, that contains only primary particles, or primary particles admixed with small flocculates. Small flocculates are those that, when present together with primary particles, are small enough such that the presence of any those small flocculates together with primary particles does not cause the dispersion to have a haze that exceeds a value, in order of increasing preference, such as about 5.0%, about 3.0%, about 2.0%, about 1.0% or about 0.5%. As noted above, the dispersion may also be mixed at high shear in this embodiment if desired to maximize the extent of the dispersion of the particles within the dissolved polymer system, and to assist in the reduction of the size of any flocculated particles to a size giving the haze properties stated above.

Yet another embodiment of this invention is a composition comprising a combination of all of the features set forth above. Yet another embodiment of this invention is a composition comprising any subcombination of less than all of those features, in which instance the composition is characterized by the absence of those features not included in the subcombination. For example, a composition of this invention, or the materials used in a process of this invention, may be characterized by any combination or subcombination of any of the features disclosed herein concerning the choice of, and/or identity of, the particle, particle size, and amount of particles, polymer, polymer precursor, solvent, additives, dispersion, matrix or end use.

From a dispersion prepared as described above, a coating can be made on a substrate by a process such as spinning, dipping, jet printing or the use of doctor-blades or wire-wound rods. A coating is a layer of material supported on one side by a substrate. The substrate may be rigid, as in a glass plate, or it may be flexible, as in a polymer film. Coatings may be applied to one or both sides of a substrate depending on the requirements of the purpose for doing so. Examples of suitable substrates include flat or shaped objects such as a silicon wafer, a lens, glass, and a polymer film such as that made form polyethylene terephtalate or plasticized polyvinylbutyral.

After a coating is formed, any remaining solvent is allowed to escape at room temperature, but volatilization may alternatively also be performed on a hot plate, in an oven or even under vacuum in a drying oven, depending on the volatility and flammability of the solvent.

Coatings made by this method that are subsequently patterned are also useful as photonic devices such as waveguides. Coatings made by this method are also useful as materials that can be transferred to other materials such as those described in U.S. Pat. No. 5,487,939.

A film or sheet can be made from a composition of this invention by any of several well-known processes. A film is a layer of material that is supported on one or more edges only, i.e. there is at least a minimum amount of an unsupported span, and is not in intimate contact with a substrate over its entire span. A sheet is a layer of material that is unsupported by a substrate, is sometimes difficult to roll, and is usually found in a nearly flat state. Films may be formed by methods such as casting the dispersion on a carrier, drying and/or curing the dispersion and removing it from the carrier. Films may also be formed by completely removing the solvent using a method such as rotary or vacuum evaporation, leaving the particles suspended in the matrix polymer or even a plasticized matrix polymer. If the concentration of particles in the dispersion is as desired in the film, standard polymer processing techniques such as pressing and extrusion may be used to form a particle-containing film. If there is a higher concentration of particles in the dispersion than desired in the film, the dispersion may be let down into additional matrix polymer in a manner similar to that in which a color concentrate is blended with an amount of polymer in which a lighter shade of the color is attained. This dilution process can be done in standard polymer processing equipment such as mixers and extruders. Sheets may also be formed by pressing or extrusion, and films or sheets or both may be used as components in a multi-layer laminate.

Articles can be formed by methods such as introducing the dispersion to a mold. A composition of this invention may be molded, for example, as a display, a filter, an optical element, a heating element or a window.

Films, sheets and coatings made by this process are useful as interlayers in laminated windows. An interlayer is a film or sheet that is specifically useful for interposing between two transparent plates for the creation of a laminated structure. A laminate is comprised of a first and a second transparent plates and an interlayer film interposed therebetween. Interlayers made in this method have very low levels of haze, have high levels of visible transmission and optionally have reduced solar heat gain coefficients when compared to samples made by conventional methods where the dispersions are dried, calcined and milled. An interlayer, or other transparent article, made from a composition of this invention may, for example, have a level of haze that does not exceed a value, in order of increasing preference, such as about 5.0%, about 3.0%, about 2.0%, about 1.0% or about 0.5%.

If reactive groups are present, it is possible to react unreacted groups after fabrication to form crosslinked or other desired materials that contain highly dispersed ultrafine particles. It is possible during the reaction of unreacted groups that the fabricated materials can be patterned. Conventional patterning techniques, including without limitation the use of photomasks in contact or proximity printing or other photolithographic methods, can be used to create patterns in the particle-filled materials, thereby creating for example optically active or passive waveguide structures, or other functional materials where transparency is important. Particle-filled films can be patterned using ablative methods such as reactive ion etching to create features with similar functions.

### EXAMPLES

The advantageous effects of this invention are demonstrated by a series of examples, as described below. The embodiments of the invention on which the examples are based are illustrative only, and do not limit the scope of the appended claims. The significance of the examples is better understood by comparing the results obtained from these embodiments of the invention with the results obtained from certain formulations that are designed to serve as controlled experiments since they do not possess the distinguishing features of this invention.

Measurements in the following examples are made according to the following standards. Solar heat gain coefficient (SHGC), according to the National Fenestration Rating Council (NFRC), the is the ratio of the solar heat gain entering the space through the fenestration area normal to the incident solar radiation. Solar heat gain includes directly transmitted solar heat and absorbed solar radiation, which is then reradiated, conducted, or convected into the space. Visible transmittance (Tᵥᵢₛ) is the ratio of the visible light entering the space through the fenestration product normal to the incident visible light. The visible light entering a space is weighted by the photopic response of the eye.

According to the International Window Film Association, the solar transmittance (Tsol) is the ratio of the amount of total solar energy in the full solar wavelength range (300 to 2,100 nanometers) that is allowed to pass through a glazing system to the amount of total solar energy falling on that glazing system. According to the Society of the Plastics Industry Inc., haze is the percentage of transmitted light that, in passing through a specimen, deviates from the incident beam by forward scattering. For the purpose of this method only light flux deviating more than 2.5 degrees on the average is considered to be haze. Haze is thus reported as a percentage, and is determined according to ASTM D-1003-61.

Optical properties of laminates and insulated glass units (IGU) including experimental coatings, films and or interlayer materials can be predicted using software available from Lawrence Berkeley National Laboratories. Transmission and reflection spectra of the materials are measured and input to the software. Simulated laminates and IGUs are constructed using various geometries and materials and the optical and heat flux properties are predicted. All reported values of visible transmission (Tvis), solar transmission (Tsol) and solar heat gain coefficient (SHGC) were acquired in this manner.

### Examples 1-12

25 gm of antimony-doped tin oxide Nyacol® DP5730A, lot #NPI-20-111 from Nyacol Nano Technologies Inc (Megunko Road, P.O. Box 349 Ashland, Mass. 01721) was placed in a capped 25 ml Teflon® PFA bottle (St. Gobain Performance Plastics, 150 Dey Road, Wayne, N.J. 07470). The sealed bottle is in turn placed into the bottom of the 400 cc thick-walled steel autoclave. Subsequently, 200 ml water was added to vessel, and the vessel sealed with a thick-walled steel cap. The steel tube and its contents were heated at 2.5 degrees centigrade per minute to the desired temperature, and held at that temperature for the desired time. The temperatures and times for these examples are listed in Table 1. During cooling, cool air was blown on the outside of the steel vessel. Upon-completion of the hydrothermal cycle, the Teflon® PFA bottle and its contents were removed from the steel vessel. The Teflon® PFA bottle was subsequently opened, and the contents were transferred to a polypropylene centrifuge tube, which was then sealed and placed in a Branson 2510 ultrasonic bath (Branson Ultrasonic Corporation, Applied Technologies Group, 41 Eagle Road, Danbury, Conn. 06813) for 30 minutes.

Particle size measurements were made using dynamic light scattering on a BI-9000 Goniometer (Brookhaven Instrument Corp., 750 Blue Point Road, Holtsville, N.Y. 11742) equipped with a Spectra-Physics 633 nm He—Ne laser (Thermo Electron, 81 Wyman Street Waltham, Mass. 02454). The data was processed using BI 9000 Particle Sizing software (Brookhaven Instruments Corporation) using the dynamic light scattering method. Samples (0.75 g) were diluted with water (3.25 g) containing ammonium hydroxide (pH=10) and again sonicated for 10 minutes for the dynamic light scattering characterization. Measurements were obtained with the detector at 90 degrees from the incident light. Results are given in Table 1.

TABLE 1
Particle size data

| | Temperature | | Effective |
|---|---|---|---|
| Example | (° C.) | Time (hrs) | Diameter (nm) |
| 1 | 200 | 2 | 32.0 |
| 2 | 245 | 2 | 34.9 |
| 3 | 245 | 18 | 38.2 |
| 4 | 155 | 18 | 36.2 |
| 5 | 245 | 10 | 41.7 |
| 6 | 200 | 10 | 36.7 |
| 7 | 200 | 18 | 37.4 |
| 8 | 155 | 2 | 41.0 |
| 9 | 200 | 18 | 35.7 |
| 10 | 155 | 10 | 36.5 |
| 11 | 200 | 10 | 38.4 |
| 12 | 155 | 10 | 37.8 |

Optical characterization was performed with a Varian, Cary 5 UV/VIS/NIR Spectrophotometer from 300 to 3000 nm. Samples were prepared by putting the undiluted sample material in a quartz cuvette with an optical path length of 0.1 mm. Data obtained using this method were manipulated to remove surface reflections from the quartz cuvette. This data was then input as a simulated interlayer to software programs Optics Version 5.1 (Maintenance Pack 2) and Window 5.2 v5.2.12, (available from Lawrence Berkeley National Laboratories, Berkeley, Calif.). Glass laminates were simulated using additional data in the database. The structures of the simulated laminates were (from exterior to interior) a 3 mm clear glass lite, followed by the modified optical data from the example material, followed by a 15 mil layer of film prepared from Butacite® polymer, followed by a 6 mm clear glass lite.

Alternately, the 6 mm clear glass lite was replaced with a 6 mm lite of K glass from Pilkington, with the low emissivity coating on the air-side of the laminate. The properties of the simulated laminates, including visible transmittance (Tvis), solar transmittance (Tsol) and solar heat gain coefficient (SHGC) are shown in Table 2.

TABLE 2
Properties of simulated laminates.

| | | | | Tvis | Tsol | SHGC |
|---|---|---|---|---|---|---|
| | Tvis Clear6 | Tsol Clear6 | SHGC Clear6 | Pilkington K | Pilkington K | Pilkington K |
| Ex | Laminate | Laminate | Laminate | Laminate | Laminate | Laminate |
| 1 | 0.853 | 0.678 | 0.753 | 0.780 | 0.563 | 0.628 |
| 2 | 0.802 | 0.539 | 0.659 | 0.733 | 0.466 | 0.552 |
| 3 | 0.682 | 0.392 | 0.560 | 0.623 | 0.344 | 0.457 |
| 4 | 0.873 | 0.713 | 0.777 | 0.798 | 0.586 | 0.646 |
| 5 | 0.766 | 0.465 | 0.611 | 0.713 | 0.431 | 0.524 |
| 6 | 0.841 | 0.610 | 0.708 | 0.782 | 0.551 | 0.618 |
| 7 | 0.841 | 0.607 | 0.706 | 0.782 | 0.549 | 0.617 |
| 8 | 0.854 | 0.660 | 0.741 | 0.795 | 0.584 | 0.644 |
| 9 | 0.838 | 0.607 | 0.711 | 0.779 | 0.549 | 0.617 |
| 10 | 0.858 | 0.662 | 0.743 | 0.799 | 0.586 | 0.646 |
| 11 | 0.840 | 0.611 | 0.709 | 0.781 | 0.551 | 0.619 |
| 12 | 0.857 | 0.661 | 0.743 | 0.797 | 0.586 | 0.646 |

### Example 13

150 gm of doped tin oxide Nyacol® DP5730A, lot #NPI-20-111 from Nyacol Nano Tech was placed in a capped 100 ml Teflon® PFA bottle. The sealed bottle is in turn placed into the bottom of the 1300 cc thick-walled steel autoclave. Subsequently, 800 ml water added to vessel, and the vessel sealed with a thick-walled steel cap. The steel tube and its contents were heated over 2.5 hours to 245° C., and held at that temperature for the 18 hours. During cooling, cool air was blown on the outside of the steel vessel. Upon completion of the hydrothermal cycle, the Teflon® PFA bottle and its contents were removed from the steel vessel. The Teflon® PFA bottle was opened, and the contents were transferred to a 100 ml glass bottle, which was subsequently sealed and placed in a Branson 2510 ultrasonic bath for 30 minutes. The average particle size as measured by dynamic light scattering was 37.5 nm.

### Example 14

20 grams of material produced in Example 13 was placed in a 100 ml glass jar. To this was added water (60 grams) containing ammonium hydroxide to adjust the pH to 10, which was subsequently placed in an ultrasonic bath for 5 minutes (Branson). The resulting material was transferred to a 500 ml round-bottom flask equipped with center neck and side thermowell, heating mantle and a Teflon® coated stir bar. While stirring rapidly, 3 grams Triton X-100 (Aldrich) was added, followed quickly by 400 grams of N,N-dimethylacetamide. To the center neck of the flask was connected a Barret Moisture Trap with bottom drain below a Hopkins coil condenser. The system was purged and subsequently blanketed with nitrogen. The system was then rapidly heated to boiling, and a total of 290 ml of solution was distilled off and discarded. After cooling, the remaining material was added to a 500 ml round bottom flask. To this flask was added 6 grams polyvinylbutyral (Aldrich) that had been previously dissolved in 60 grams N,N-dimethylacetamide. Excess N,N-dimethylacetamide was removed using rotary evaporation under vacuum up to 70° C. over one hour.

Films of this material were cast on 1 inch by 3 inch microscope slides using casting blades and allowed to dry overnight under vacuum at 90° C. The resulting films were slightly blue-green in color. Haze values (Gardner Haze Meter, BYK-Gardner USA, 9104 Guilford Road, Columbia, Md. 21046) measured on these films were 0.52%. In addition, several drops of the coating solution were coated onto a Teflon® fluoropolymer sheet, dried and characterized using a JEM 2011 transmission electron microscope (JEOL USA, Inc., 11 Dearborn Road Peabody, Mass. 01960). The average particle size in the composite was less than 5 nm. Films were subsequently cast from the coating solution onto a film prepared from Mylar® polymer.

### Examples 15-16

Samples similar to Example 14 were made, the major difference being that the level of Triton X-100 was varied. 0.6 grams of Triton X-100 was used in Example 15, and 0.2 grams Triton X-100 was used in Example 16. Films of these materials were cast on glass slides using a casting blade. Transmission spectra were very similar to materials made in Example 14.

### Example 17

1.5 grams of material produced in Example 13 was mixed with 4.5 grams water that had previously been adjusted to pH of 10 using ammonium hydroxide in a glass vial which was subsequently sealed. The suspension was sonicated for 5 minutes as in Example 14. The resulting material was transferred to a 100 ml round-bottom flask equipped with center neck and side thermowell, heating mantle and a Teflon® fluoropolymer coated stir bar. While stirring rapidly, 30 grams of N,N-dimethylformamide was added. To this suspension, a solution of 0.51 grams polyvinylbutyral (Mowital B30T, Clariant Corporation, 4000 Monroe Rd., Charlotte, N.C., 28205) resulting in a turbid suspension. To the center neck of the flask was connected a Barret Moisture Trap with bottom drain below a Hopkins coil condenser. The system was purged and subsequently blanketed with nitrogen. The system was then rapidly heated to boiling, and a total of 15 ml of solution was distilled off and discarded. On heating, the suspension became a transparent green color. After cooling, the remaining material was transferred to a 100 ml round bottom flask. Excess N,N-dimethylformamide was removed using rotary evaporation under vacuum up to 50° C. over one hour. Films were cast on 1 inch by 3 inch microscope slides using casting blades and allowed to dry overnight under vacuum at 90° C. The resulting films were slightly blue-green in color. Haze values (Gardner Haze Meter) measured on these films were 0.88%.

Where a composition or process of this invention is stated or described as comprising, including, containing, having, being composed of or being constituted by certain components or steps, it is to be understood, unless the statement or description explicitly provides to the contrary, that one or more components or steps in addition to those explicitly stated or described may be present in the composition. In an alternative embodiment, however, the composition or process of this invention may be stated or described as consisting essentially of certain components or steps, in which embodiment components or steps that would materially alter the principle of operation or the distinguishing characteristics of the composition or process are not present therein. In a further alternative embodiment, the composition or process of this invention may be stated or described as consisting of certain components or steps, in which embodiment components or steps other than those stated or described are not present therein.

Where the indefinite article “a” or “an” is used with respect to a statement or description of the presence of a component or step in a composition or step of this invention, it is to be understood, unless the statement or description explicitly provides to the contrary, that the use of such indefinite article does not limit the presence of the component in the composition or step in the process to one in number.

What is claimed is:

1. A process for dispersing particles in a polymer, comprising
(a) providing an aqueous dispersion of particles,
(b) admixing with the aqueous dispersion of particles at least one solvent that is miscible with water and does not undergo liquid-liquid phase separation as water is removed from the dispersion; and
(c-1) removing water from the dispersion, and
(d-1) adding to the dispersion at least one polymer that is soluble in the solvent; or
(c-2) adding to the dispersion at least one polymer that is soluble in the solvent, and
(d-2) removing water from the dispersion.

2. A process for dispersing particles in a polymer, comprising
(a) providing an aqueous dispersion of particles,
(b) admixing with the aqueous dispersion of particles at least one solvent that is miscible with water and does not undergo liquid-liquid phase separation as water is removed from the dispersion; and
(c-1) removing water from the dispersion,
(d-1) adding to the dispersion at least one polymer precursor that is soluble in the solvent, and
(e-1) polymerizing the precursor to form within the dispersion at least one polymer; or
(c-2) adding to the dispersion at least one polymer precursor that is soluble in the solvent,
(d-2) polymerizing the precursor to form within the dispersion at least one polymer, and
(e-2) removing water from the dispersion.

3. The process of claim 1 or 2 further comprising a step of removing solvent from the dispersion to form a dispersion of particles in a matrix of the polymer.

4. The process of claim 1 or 2 wherein the polymer is selected from one or more members of the group consisting of poly(vinylbutyral), ethylene/vinyl acetate copolymer, acrylic polymers and copolymers, methacrylic polymers and copolymers, styrenic polymers and copolymers, epoxy-containing polymers and copolymers, ionomers, and diblock copolymers.

5. The process of claim 1 or 2 wherein the particles are selected from the group consisting of antimony-doped tin oxide, tin-doped indium oxide, cobalt oxide, aluminum oxide, titanium oxide, nickel oxide, iron oxide, zinc oxide, chromium oxide, calcium fluoride, rare earth-doped calcium fluoride, copper phosphate, iron phosphate and mixtures thereof.

6. The process of claim 1 or 2 wherein the average diameter of the particles is less than 200 nm.

7. The process of claim 1 or 2 wherein the particles are functionalized particles.

8. The process of claim 1 or 2 wherein the solvent has a boiling point higher than water.

9. The process of claim 1 or 2 wherein the solvent is selected from the group consisting of N,N-dimethylformamide, N-methyl-2-pyrrolidinone, and N,N-dimethylacetamide.

10. The process of claim 1 or 2 further comprising a step of adding a surfactant to the dispersion.

11. The process of claim 1 or 2 further comprising a step of adding to the dispersion one or more additives selected from the group consisting of a plasticizer, a stabilizer, and a dye that absorbs in light between 400 and 3000 nm.

12. The process of claim 1 wherein the particle is antimony-doped tin oxide, the solvent is N,N-dimethylacetamide, and the polymer is poly(vinylbutyral); and wherein the process further comprises adding to the dispersion C₁₄H₂₂O(C₂H₄O)ₙ where n is 9 or 10.

13. The process of claim 1 wherein the particle is antimony-doped tin oxide, the solvent is N,N-dimethylformamide, and the polymer is poly(vinylbutyral).

14. The process of claim 2 wherein the particle is calcium fluoride, the solvent is N,N-dimethylacetamide, and the polymer precursor is an acrylic monomer; and wherein the process further comprises adding to the dispersion 3(trimethoxy)propylmethacrylate.

15. The process of claim 1 or 2 wherein the step of removing water forms a dispersion of particles that has a haze not exceeding 5% as determined according to ASTM D-1003-61.

16. The process of claim 1 wherein the step of adding polymer forms a dispersion of particles that has a haze not exceeding 5% as determined according to ASTM D-1003-61.

17. The process of claim 2 wherein the step of polymerizing polymer precursors forms a dispersion of particles that has a haze not exceeding 5% as determined according to ASTM D-1003-61.

18. The process of claim 1 or 2 further comprising a step of fabricating a film, sheet, coating or molded article from the dispersion.

19. A composition of matter comprising particles and at least one polymer,
wherein the particles have an average diameter of less than 200 nm, are dispersed in the polymer(s) and are present in the composition in an amount of at least about 1% based on the combined weight of the particles and the polymer(s), and
wherein the composition has a haze not exceeding 5% as determined according to ASTM D-1003-61.

20. The composition of claim 19 wherein the particles have an average diameter of less than 20 nm, and are present in the composition in an amount of at least about 20%, and
wherein the composition has a haze not exceeding 1.0% as determined according to ASTM D-1003-61.

21. The composition of claim 19 wherein the particles are antimony-doped tin oxide and a polymer is poly(vinylbutyral).

22. The composition of claim 19 fabricated as a film, sheet, coating or molded article.

23. The composition of claim 22 wherein the molded article is a display, a filter, an optical element, a heating element or a window.
